(19) United States
(12) Patent Application Publication
(10) Pub. No.: US 2026/0030019 A1
(43) Pub. Date: Jan. 29, 2026

(54) CONTINUOUS INTEGRATION AND DEPLOYMENT OF PROGRAMMATIC ENVIRONMENTS

(71) Applicant: T-Mobile USA, Inc., Bellevue, WA (US)

(72) Inventors: Nicholas Robert Criss, Seattle, WA (US); Anand Kumar Ganapathy, Maple Valley, WA (US); Vipin Jose, Atlanta, GA (US); Glen Kurisingal, Sammamish, WA (US); Kristopher William Wilson, Sammamish, WA (US)

(21) Appl. No.: 18/786,303

(22) Filed: Jul. 26, 2024

(51) Int. Cl. G06F 8/71; G06F 8/76

(52) U.S. Cl. CPC G06F 8/71; G06F 8/76

(57) ABSTRACT

Systems and methods for continuous deployment and integration of computer programs within a coding infrastructure are disclosed herein. The system receives one or more files comprising (1) computer code and (2) data for configuring implementation of the computer code within a new programmatic environment. The system can then generate the new programmatic environment by applying a configuration defined in the file(s) and can add the new programmatic environment to a set of existing environments, wherein each environment is classified by a current state indicative of a stage of development. The system initiates execution of a suite of tests for testing performance of the new programmatic environment and, responsive to an indication that the new programmatic environment successfully completed the first suite of tests, updates the current state of the new programmatic environment. The system can configure a volume of network flow processed by the new programmatic environment.

### BACKGROUND

A telecommunications network is established via a complex arrangement and configuration of many cell sites that are deployed across a geographical area. For example, there can be different types of cell sites (e.g., macro cells, microcells, and so on) positioned in a specific geographical location, such as a city, neighborhood, and so on. These cell sites strive to provide adequate, reliable coverage for mobile devices (e.g., smart phones, tablets, and so on) via different frequency bands and radio networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS), Enhanced Data rates for GSM Evolution (EDGE), Universal Mobile Telecommunications System (UMTS), or Long Term Evolution (LTE) network), 5G mobile communications network, IEEE 802.11 (WiFi), or other communications networks. The devices can seek access to the telecommunications network for various services provided by the network, such as services that facilitate the transmission of data over the network and/or provide content to the devices.

Networks like these facilitate interconnectedness between devices so that services and applications that are hosted on servers can share data across devices. Many of these hosted services are developed using continuous delivery (CD). Continuous Delivery is a software development methodology where development teams create and release software in frequent and short development cycles. The primary goal is to ensure that the software can be deployed and released to production at any point in time with high reliability and minimal manual intervention. This process involves setting up an automated pipeline that takes the software from development through various testing and staging environments that mimic the production environment as closely as possible. By automating this pipeline, the software can be tested rigorously and consistently, and any issues or bugs can be identified and resolved early in the development process. The ultimate aim is to make software delivery more efficient, predictable, and less error prone, allowing for rapid and reliable releases.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A is a block diagram illustrating a suitable computing environment within which to perform continuous deployment and integration of computer programs within a coding infrastructure.

FIG. 3B is a block diagram illustrating the components of an exemplary continuous deployment and integration system.

FIG. 4 is a block diagram illustrating an exemplary progression of a programmatic environment through deployment.

FIG. 5 is a flow diagram illustrating a process for continuous deployment and integration of computer programs within a coding infrastructure.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

While Continuous Integration/Continuous Delivery (CI/CD) is important in enabling users to flexibly develop and deploy software with high reliability and minimal manual intervention, it is often difficult to implement effectively. For example, to effectively implement continuous delivery, software applications must adhere to specific architecturally significant requirements (ASRs), including deployability, modifiability, and testability. These ASRs are crucial and should not be overlooked or compromised.

To adhere to these requirements, in typical Continuous Integration/Continuous Delivery (CI/CD) pipelines, code transitions through various long-standing, manually maintained environments (such as development, testing, staging, and production). While this approach works well for simpler systems like those implementing simple microservices, it can be problematic to adopt for more complex systems. For example, differences between these environments might lead to the failure of automated tests or, in more severe cases, the undetected passage of defects. Where software is of critical importance, such as in healthcare, it is difficult to employ continuous deployment as systems cannot be down for even minutes, but it is worse yet to pass defects due to problems in the environment.

Accordingly, a mechanism is desired that facilitates the continuous delivery of applications (e.g., computer code) that are not inherently optimized for deployability, such as traditional monolithic systems. One mechanism for doing so can be achieved through orchestrating, deploying, and managing complete environments, including infrastructure, code, and configurations that are highly consistent due to their deterministic creation through automated processes, as opposed to passing code between different environments.

In particular, systems and methods disclosed herein enable an entire environment to be updated as progression changes (e.g., to being closer to deployment). For example, rather than shifting code into a development environment and then into a release environment, the disclosed system enables the entire environment (e.g., code comprising the deployment changes and code that directs the infrastructure, such as how many servers to provision to run code on) to be updated as the progression to production changes on stacks that are continually monitored via a system that has a plurality of independent stacks (e.g., if you break something on one stack, the others are not affected) that are able to coexist (e.g., able to service user requests at the same time without transaction inconsistencies). As time goes on, the environment can be promoted to full production (e.g., upon passing a performance testing phase) and more traffic can be routed to the stack over time and the stack can be monitored continually for changes, and traffic to each stack can be automatically modified based on changes in performance.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

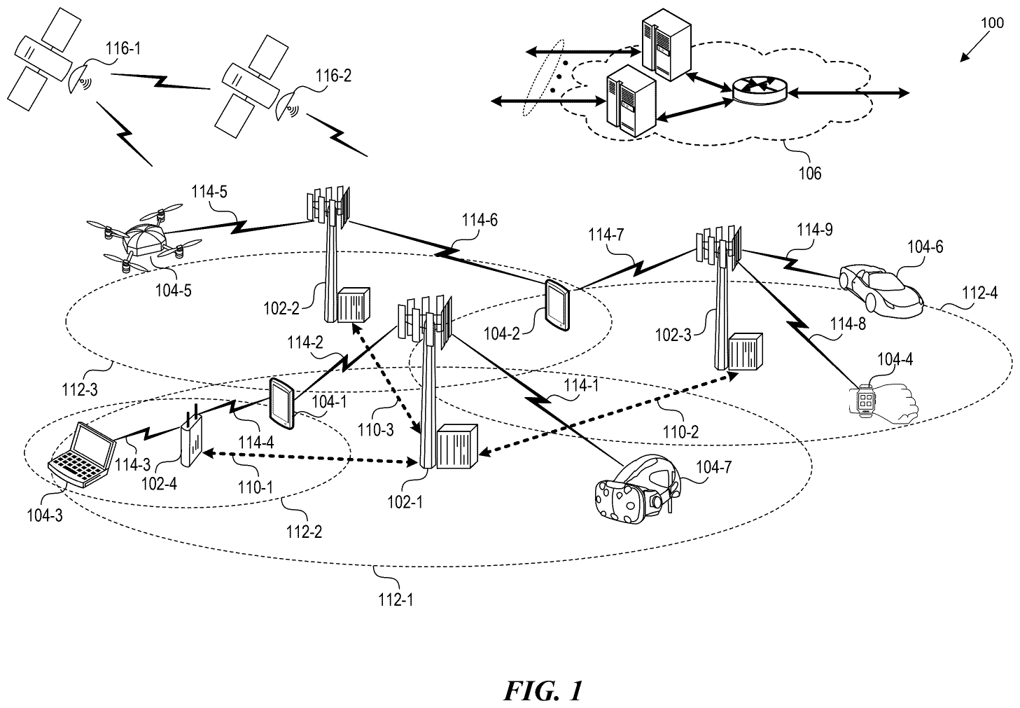

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, cNodeB (CNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., SI interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 provides communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station as compared to a macro cell and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100, including macro cNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions, while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (TH2) communications. This can support wireless applications that demand ultra-high quality of service requirements and multi-terabits per second data transmission in the 6G and beyond era, such as terabit-per-second backhaul systems, ultra high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged WiFi and Core architecture to increase and improve indoor coverage.

### 5G Core Network Functions

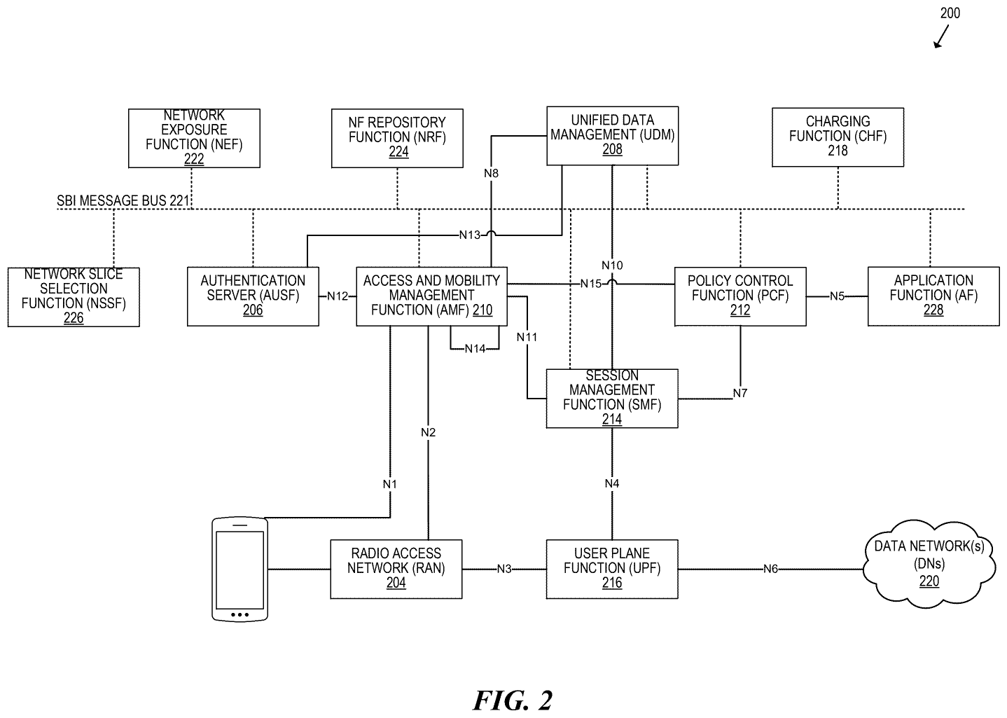

FIG. 2 is a block diagram that illustrates an architecture 200 including 5G core network functions (NFs) that can implement aspects of the present technology. A wireless device can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

Although exemplary embodiments are described herein with reference to telecommunications and networks, the concepts of the present invention are not limited in application to such networks. It will be appreciated by those of skill in the art that the concepts of the present invention may be applied outside of telecommunications and networking, such as through a single device or a cluster of remote devices.

### Suitable Computing Environments

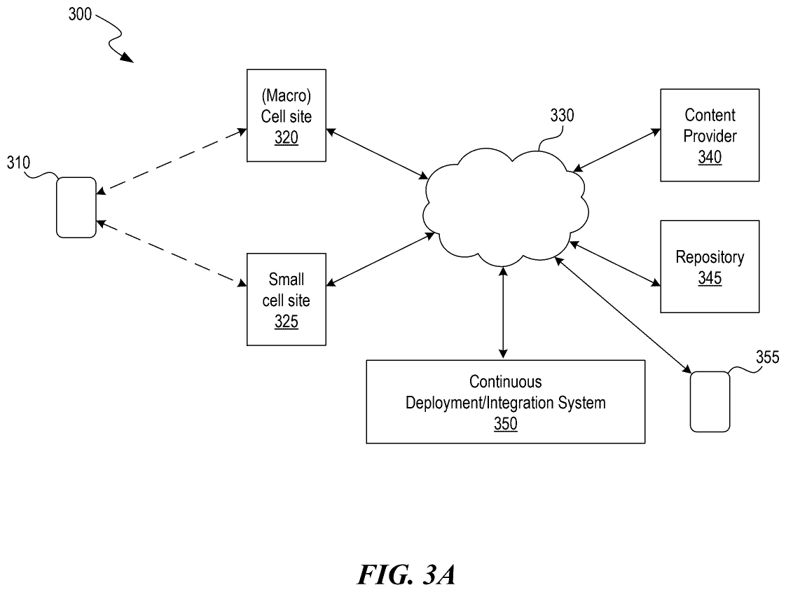

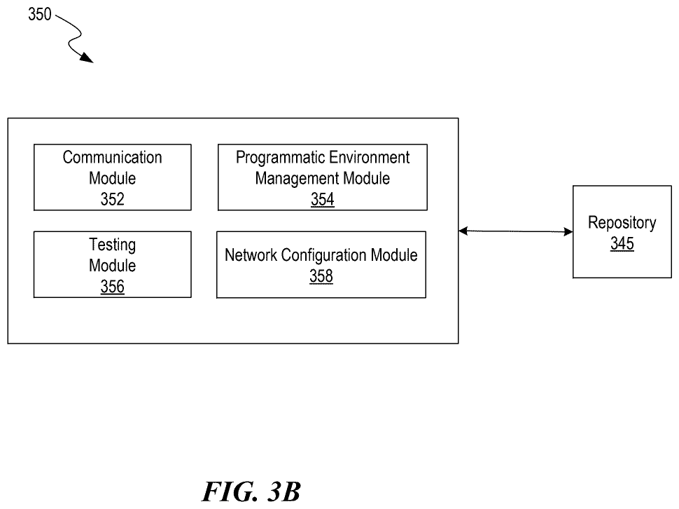

FIG. 3A is a block diagram illustrating a suitable computing environment within which to perform continuous deployment and integration of computer programs within a coding infrastructure. As described herein, the computing environment 300 of FIG. 3 can be used to generate and pass whole environments through the deployment process, rather than the traditional method of passing code through different environments. The system can be used to create new environments (also referred to herein as stacks), update environments, and delete environments as well.

Computing environment 300 can include one or more user device(s) 310, one or more cell sites 320 and 325, telecommunications network 330, content provider 340, cloud data repository 345, one or more other user devices 355, and continuous deployment/integration system 350. User device(s) 310, such as mobile devices or user equipment (UE) associated with users (such as mobile phones (e.g., smartphones), tablet computers, laptops, and so on), Internet of Things (IoT) devices, vehicles (e.g., smart vehicles), devices with sensors, and so on, can be configured to receive and transmit data, stream content, and/or perform other communications or receive services over a telecommunications network 330, which is accessed by the user device 310 over one or more cell sites 320, 325. For example, the mobile device 310 accesses a telecommunication network 330 via a cell site at a geographical location that includes the cell site, in order to transmit and receive data (e.g., stream or upload multimedia content) from various entities, such as a content provider 340, repository 345, and/or other user devices 355 on the network 330 and via the cell site 320.

The cell sites can include macro cell sites 320, such as base stations, small cell sites 325, such as picocells, microcells, or femtocells, and/or other network access component or sites. The cell cites 320, 325 can store data associated with their operations, including data associated with the number and types of connected users, data associated with the provision and/or utilization of a spectrum, radio band, frequency channel, and so on, provided by the cell sites 320, 325, and so on. The cell sites 320, 325 can monitor their use, such as the provisioning or utilization of physical resource blocks (PRBs) provided by a cell site physical layer in LTE network; likewise the cell sites can measure channel quality, such as via channel quality indicator (CQI) values, etc.

As described herein, the continuous deployment/integration system 350 can be used to facilitate the continuous delivery of applications that are not inherently optimized for deployability, such as by orchestrating, deploying, and managing complete environments, including infrastructure, code, and configurations that are highly consistent due to their deterministic creation through automated processes, e.g., as opposed to passing code between different environments. The system can access code and configuration files needed to generate and deploy an application from the repository 345. As referred to herein, an application may include or be wholly made up of computer code. As referred to herein, computer code of an application can refer to a set of instructions written in a programming language that is executed by a computer to perform specific tasks. Computer code can form logic and operations of software applications and systems. By contrast, configuration data as referred to herein can be used to customize behavior of a program. It may include settings, preferences and parameters.

Repository 345 can be a central location where code, documentation, and other project-related artifacts are stored and managed. Repository 345 can serve as a version-controlled storage space that allows multiple developers to collaborate on the codebase, track changes, and maintain a history of modifications. Although repository 345 is illustrated as a singular repository, it can be appreciated that more than one repository 345 can be used to perform the functions of a single repository 345, and that repository 345 can be representative of one or more repositories.

The repository 345 can include one or more release branches. As referred to herein, the release branch can be a branch used for preparing, finalizing, and deploying a new release of the software. The release branch can be used to perform fixes, testing and making any adjustments before the code is officially released and deployed to production. The release branch enables developers to stabilize and polish the release while working on other development on the main branch.

Repository 345 can store, for example, version-controlled copies of all artifacts needed to build the application in a folder hierarchy whose structure is specific to the deployed application. Artifacts can include compiled code, libraries, executables, containers, and/or any other file necessary to deploy and run the code. Repository 345 can include different release branches, infrastructure (infra)-as-code, application code, configuration data, pipeline code, configuration templates, and/or test definitions.

As referred to herein, release branches can reference branches on a repository that allows different versions of the same files to be used simultaneously for various purposes. This can be accomplished, for example, by assigning a point-in-time “branch label.” All committed changes after that point in time can be considered to be invisible to the branch if they weren't specifically targeted to it. Artifacts needed to create a stack can be accessible by a release branch, allowing release-specific changes to artifacts without impacting other releases.

As referred to herein, infra-as-code can be used to deterministically provision application infrastructure (e.g., virtual machines, databases, docker containers). The infra-as-code languages and tools used can be specific to the deployed application as is the provisioned infrastructure. The infra-as-code can be accessed and modifiable as part of a release branch, in some embodiments.

As referred to herein, application code can refer to code that contains the functional logic for the application. Source code can be compiled into executable code, which is deployed to the provisioned infrastructure that was created by the infra-as-code. Provisioned infra runs the executable code in response to user requests. All application code is accessible and modifiable as part of a release branch.

As referred to herein, configuration data (also referred to as “config”) can include persisted data read by the running executable code affecting the behavior of the application (e.g., feature on/off toggles). Complex applications can use external configuration management systems that inject configuration values into files via replacement variables (especially for security-sensitive secrets). Configuration data can be accessible and modifiable as part of a release branch.

As referred to herein, pipeline code can include a series of code modules (e.g., steps) that can chain together in various ways to automate complex orchestration processes. Most complex processes (e.g., infra creation, app build and deployment, testing and release) are implemented via pipelines. All pipeline code and configuration data (e.g., describing how steps are chained together) can be accessed and modified as part of a release branch.

As referred to herein, a configuration template can refer to a pipeline that can change the configuration and scale of a stack without requiring the reprovision of infrastructure or redeployment of the application. A configuration template can be used to apply a common, preset configuration and infrastructure scale to any stack as needed, especially to change for various stages of the release progression. Configuration templates can be accessed and modified as part of a release branch. According to some examples, the configuration template itself can include code or other programmatic language. In one specific example, the code of the configuration template can be associated or transmitted with the release candidate. As part of the change to the system (e.g., software), the configuration template may be changed for a given release process. The configuration template may be updated manually, e.g., by a user, or automatically.

As referred to herein, a test definition can refer to code for making deterministic calls to running executable code and configuration data that defines specific pass/fail criteria for the results. Test definitions can be accessed and modified as part of a release branch.

As described, continuous deployment/integration system 350 can access code and configuration files needed to generate and deploy an application from the repository 345 via network 330. For example, the system can receive one or more files comprising (1) computer code and (2) data for configuring implementation of the computer code within a new programmatic environment, e.g., from the repository 345 via network 330 and use the data to generate a new programmatic environment, also referred to herein as a stack. For example, the programmatic environment can comprise a runnable collection of provisioned infrastructure containing compiled executable code and configuration data for the application. The system can then use the newly generated programmatic environment and progress it through a series of stages, e.g., from development to full production release.

The system can be enabled to continually monitor the execution of certain stacks with live traffic upon successful progression to a later state (“canary state”). For example, the system can be enabled to minimize or expand the amount of traffic configured to flow into the specific stack responsive to anomalies or successful testing. Further, when changes are committed, depending on the stage the stack has progressed to, different operators and developers can be updated, e.g., via notifications to user device(s) 310.

FIG. 3 and the discussion herein provide a brief, general description of a suitable computing environment 300 in which the continuous deployment/integration system 350 can be supported and implemented. Although not required, aspects of the continuous deployment/integration system 350 are described in the general context of computer-executable instructions, such as routines executed by a computer, e.g., mobile device, a server computer, or personal computer. The system can be practiced with other communications, data processing, or computer system configurations, including: Internet appliances, handheld devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer-implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In alternative implementations, the mobile device or portable device can represent the server portion, while the server can represent the client portion.

In some implementations, the user device 310 and/or the cell sites 320, 325 can include network communication components that enable the devices to communicate with remote servers or other portable electronic devices by transmitting and receiving wireless signals using a licensed, semi-licensed, or unlicensed spectrum over a communications network, such as telecommunications network 330. In some cases, the telecommunications network 330 can be comprised of multiple networks, even multiple heterogeneous networks, such as one or more border networks, voice networks, broadband networks, service provider networks, Internet Service Provider (ISP) networks, and/or Public Switched Telephone Networks (PSTNs) interconnected via gateways operable to facilitate communications between and among the various networks. The telecommunications network 330 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS), Enhanced Data rates for GSM Evolution (EDGE), Universal Mobile Telecommunications System (UMTS), or Long Term Evolution (LTE) network), 5G mobile communications network, IEEE 802.11 (WiFi), or other communications networks. Thus, the user device is configured to operate and switch among multiple frequency bands for receiving and/or transmitting data.

Further details regarding the operation and implementation of the continuous deployment/integration system 350 will now be described.

### Examples of Systems for Continuous Deployment and Integration

FIG. 3B is a block diagram illustrating the components of an exemplary continuous deployment and integration system. Continuous deployment/integration system 350 can include functional modules that are implemented with a combination of software (e.g., executable instructions, or computer code) and hardware (e.g., at least a memory and processor). Accordingly, as used herein, in some examples a module is a processor-implemented module or set of code and represents a computing device having a processor that is at least temporarily configured and/or programmed by executable instructions stored in memory to perform one or more of the specific functions described herein. For example, the continuous deployment/integration system 350 includes a communication module 352, a programmatic environment management module 354, a testing module 356, and a network configuration module 358, each of which is discussed separately below.

### Communication Module

Communication module 352 of continuous deployment/integration system 350 can include software and/or hardware components allowing for the transmission and/or receipt of information between two or more devices. Communication module 352 can include a wireless communication module, such as a cellular radio or WiFi antenna, to allow for communication over wireless networks and/or can additionally or alternatively include a network card (e.g., a wireless network card and/or a wired network card) that is associated with software to drive the card.

The communication module 352 is configured and/or programmed (e.g., via the above-mentioned techniques) to interface between a device (e.g., user device(s) 310, one or more other user devices 355), cell sites (e.g., cell sites 320, 325), content provider (e.g., content provider 340), cloud data repository (e.g., cloud data repository 345) such as via a network (e.g., network 330), to receive and transmit data including values (e.g., time-series) for a set of network performance parameters. When communication module 352 receives data, the module can pass on relevant portions of data to different modules of the continuous deployment/integration system 350. Communication module 352 can also be configured to generate and transmit notifications and/or recommendations to operators.

As described herein, when a new release is needed, e.g., because of new application code for a service, or because existing application code got updated or modified in some way, the communication module 352 can receive data needed for the new release. For example, the communication module 352 can receive, via user device(s) 310, a request, such as from a developer, to initiate the development and deployment process. For example, the request can include one or more files comprising the computer code, e.g., the application code. The request can also include data for configuring implementation of the computer code within a new programmatic environment.

Alternatively, or additionally, rather than receiving the code and data via a request, the system can receive the code and data from a repository. For example, the communication module 352 receives the files from the repository 345 via the network 330. In some examples, the computer code can comprise one or more files or data structures, such as the application code described herein. The data for configuring implementation of the computer code within the new programmatic environment can include any of the infra-as-code, configuration data, pipeline data, or configuration templates discussed herein.

The computer code and data for configuring implementation of the computer code can be passed, or a pointer to the data in memory can be passed, to the other modules of the system, such as to programmatic environment management module 354 to generate the new programmatic environment by applying a configuration defined in the one or more files.

### Programmatic Environment Management Module

The programmatic environment management module 354 is configured to generate, manage, update, collect data on, and monitor any programmatic environments. The programmatic environment management module can perform operations of a stack manager, application monitor, and/or orchestrator and can comprise any combination of the stack manager, application monitor, and/or orchestrator. The module is configured to manage stacks and automate the progression of stacks to production, trigger the test framework to run tests as needed, collect data and track the state of all stacks, including what stage or state the stack has progressed to (i.e., development, functional testing, release candidate, performance testing, canary, full production), the percentage share of live traffic configured for the stack, results of automated testing, and telemetry and performance data. The module can also change the share of live traffic routed to stacks for: canary releases, canary abort, full production releases, and/or production failover/rollback. As referred to herein, a programmatic environment (also referred to herein as a stack) includes a runnable collection of provisioned infrastructure containing compiled executable code and configuration data for the application or service.

As described herein, the computer code and data for configuring implementation of the computer code can be passed, or a pointer to the data in memory can be passed, from the communication module 352 to programmatic environment management module 354 to generate the new programmatic environment by applying a configuration defined in the one or more files.

According to some examples, a new stack can be generated using a series of pipelines. Prior to executing the series of pipelines, the module can assign a unique stack name and namespace, e.g., the stack name used to refer to the stack for all subsequent operations, for each stack. The namespace can be used to insure there is no collision of any named items (e.g., infrastructure, configuration data) across stacks. Similarly, the module can create stack-unique configurations, for example, such that values used by the application or server (e.g., DNS entries) will be unique for each stack. These values are stored together and made available both as application configuration data and as values for various pipeline steps to use. Further, the module can run a security pipeline, which creates stack-unique security roles and permissions. A different security context can be used for each stack so that the compromise of one stack does not affect other stacks. These values are stored as part of stack-unique configuration.

The module can then run an infrastructure creation pipeline, which provisions new, dedicated infra for the stack. This process will both generate and use stack-unique configuration values as the stack progresses through the stages. A critical stack-unique value that is generated is the single point of entry (endpoint) used by the application gateway to route live traffic to the stack. It is desirable to have as few (or no) alternate ways to access the application and infra beyond this entry point. The module can then perform initial application deployment where pipelines are called to build application executable code and deploy the code to the newly provisioned infra. The inputted initial configuration template can be used to call the “apply configuration template” operation described below.

For example, the module can call the operation “apply configuration template” where configuration templates are designed to change common configuration values (e.g., not stack-unique) and infra scale (e.g., size, capacity) in a way that does not require the reprovision of infrastructure or the redeployment of application code. To apply a configuration template, the orchestrator executes the associated pipeline.

As referred to herein, configuration templates define preset configurations for various stages of the software development lifecycle, enabling teams to deploy applications quickly and consistently. Each template is designed to meet specific requirements and scenarios, ensuring optimal performance, security, and efficiency. For example, BAU (Business As Usual)-Development (BAU-DEV) configuration is focused on development environments. This template typically includes settings optimized for the needs of developers, such as enhanced debugging capabilities, detailed logging, and integration with development tools.

BAU-Release (BAU-REL) configuration is geared towards preparing software for release. It's a transitional phase between development and full production. This template often includes settings for performance testing, final bug fixes, and optimization. This configuration can be used to mimic the production environment as closely as possible while still allowing for last-minute adjustments and validations. Maximum Reliability (MAX-REL) configuration emphasizes stability and reliability, often used in critical systems where downtime or errors are unacceptable. This template might include advanced monitoring tools, redundant systems, and strict security measures. BAU-Production (BAU-PROD) configuration is a standard production environment setup. BAU-PROD can be used to balance performance, security, and resource utilization to suit everyday operational needs.

Minimal Production (MIN-PROD) configuration is designed for scenarios where resource utilization needs to be minimized, possibly due to cost constraints or limited hardware capabilities. The MIN-PROD configuration can strip down non-essential services and features to run the application with the least resource overhead. Hibernation (HIBERNATION) configuration is used for temporarily idling an application or system. It minimizes resource usage to the bare minimum required to keep the system in a state from which it can be quickly reactivated. Furthermore, the flexibility to define additional templates like “2X-PROD” or “MAX-PROD” allows organizations to tailor configurations to their specific needs. “2X-PROD” could scale up a production environment for double the usual load, while “MAX-PROD” configures a production environment for maximum performance and scalability, e.g., for handling peak usage periods or high-demand scenarios.

Any combination of the following configuration templates can be used: BAU-DEV, BAU-REL, MAX-REL, BAU-PROD, MIN-PROD, HIBERNATION. However, any number of templates can be defined for more complex workflows (e.g., 2X-PROD, MAX-PROD).

Once the new programmatic environment is generated, it can be added to a set of other existing programmatic environments, e.g., that can be in different stages of progression. For each of the programmatic environments, the state of progression can be indicated by a label of the programmatic environment as one of “Development.” “Release Candidate,” “Canary,” and “Full Production.” Each of the states can have associated testing that must be performed, e.g., via testing module 356, and passed in order to progress to the next state. According to some examples, in order for the stacks to be able to coexist, the stacks can be independent of each other, e.g., affecting one stack does not impact another, and the stacks must be able to service user requests at the same time without corrupting transactions.

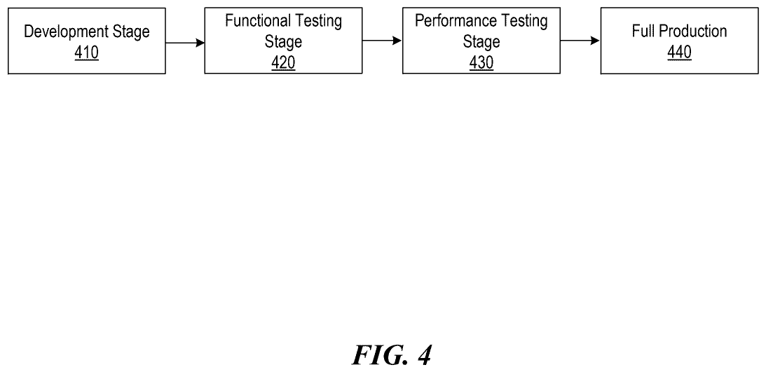

Once the new programmatic environment is generated, it can begin to progress through one or more of the stages or states of the deployment process, such as the deployment process depicted in FIG. 4. For example, each of the programmatic environments can be in considered in different states or stages. In one example, after or during development, the environment can be said to be in a development stage 410. After success at (e.g., passing threshold tests at) functional testing stage 420 it can be determined whether or not an environment is considered a release candidate. After success at (e.g., passing threshold tests at) performance testing stage 430, the environment may be considered a canary. An environment may enter the full production stage 440 subsequently.

When application changes are needed, the system can implement a new release process. For example, when the application code, the infra (via infra-as-code) and/or configuration data is modified, the system can initiate the deployment process through the development stage 410. In some examples, initiating the deployment process is automated and/or semi-attended, e.g., a developer can initiate certain steps. For example, a developer can initiate new environment creation with the stack manager, causing one or more steps to be executed. For example, as part of the development stage, the developer can initiate the creation of a new release branch in the repository to be dedicated to the new stack. According to some examples, the starting point for the branch can be based on, or be comprised of, the most recent known good (e.g., functional) production.

The module is triggered to create the new stack from the release branch artifacts. According to some examples, the module applies the BAU-DEV config template to the stack. Developers can introduce changes by committing changed artifacts to the associated release branch. In some examples, committing changes can automatically update the stack, which can further trigger the test framework to run automated functional testing, e.g., at testing module 356. At the development stage, testing does not yet connect to external dependent systems, instead relying on mock data. In some examples, developers are alerted, and test results are reported to the stack manager. Stacks that pass functional testing, e.g., functional testing stage 420, can be eligible for promotion to the next steps, including being labelled or considered as a release candidate.

As described herein, when changes are complete, a developer can initiate promotion of the environment to release candidate with the stack manager. The module (e.g., orchestrator) is triggered to apply the BAU-REL config template, closely matching what is used in production. This can include, for example, connecting to live versions of external dependent systems. The testing module 356 can be used to use test framework that, when triggered, executes end-to-end (E2E) tests to validate that the stack works as expected with dependent systems. According to some examples, the E2E tests can include the same functional tests from development, but can now be connected to live systems, rather than mock data.

According to some examples, if E2E tests fail, developers are alerted, and corrections must be made before the progression can continue. For example, corrections can only be made by updating and committing artifacts in the release branch and a stack cannot be changed directly. The module (e.g., the orchestrator) can apply the MAX-REL config template to scale the stack up to a size suitable for performance testing. The test framework can be triggered to run performance testing using testing module 356, and the test results are reported to the stack manager. Only stacks within acceptable performance margins can be eligible for promotion to live canary. After performance testing, the orchestrator can scale the stack back down by re-applying the BAU-REL config template.

In order to test changes with live traffic, a stack can progress from the release candidate state after functional testing to a canary state after performance testing. The programmatic environment management module 354 can determine an acceptable amount of live traffic for testing (e.g., 4%). In some examples, the module can determine the amount such that the amount of traffic is large enough to get an adequate sample of usage. In some examples, the amount of traffic can be selected to be as small as possible in order to minimize the impact of escape defects.

In some examples, a developer can initiate the canary state with the stack manager, specifying the percentage of traffic for the canary and the minimum period of time needed before promotion to full production is considered safe. The stack manager can then trigger the orchestrator to apply the BAU-PROD config template, setting the final config and scaling to production values. The test framework can be triggered to perform sanity testing to ensure the stack continues to work as expected in the final configuration. Responsive to a determination that sanity testing fails, the release can be aborted and the network configuration module (e.g., application gateway) is given updated traffic routing percentages. An even amount of traffic can be taken away from all current full production stacks (e.g., stacks in the full production stage). The resulting percentage of traffic can be allocated to the stack in the canary state. The stack can take live traffic for the specified period of time. If the application monitor detects an anomaly, it can trigger the stack manager to automatically restore traffic to the previous state and the canary stack no longer receives live traffic. If the period of time completes without issue, the canary stack is automatically promoted to full release.

In some examples, after a successful period of time in the canary state, the stack can be promoted to production by creating a second stack and routing all live traffic to the two new release stacks. A new release branch can be created for creating the second stack, based on the stack that successfully progressed past the canary state. The orchestrator can be triggered to create an additional stack using the BAU-PROD config template. Minimal sanity testing can be performed on the newly created stack and the release can be aborted if this test fails. The network configuration module 358 (e.g., application gateway) is given new traffic routing percentages. All traffic can be divided between the two new release stacks such that the old full production stacks no longer receive traffic. As described herein, the old stacks are retained for rollback or troubleshooting.

In some examples, rather than releasing in serial (e.g., sequentially), parallel releases enable multiple development teams to create changes without coordinating on release sequence or timing. In this example, developers can create an independent stack and follow the release progression described herein with respect to the development stage to becoming a release candidate. However, once the stack is ready for testing as a canary or during performance testing, the stack can be added to a queue and a scheduler can be used to orchestrate stacks as a canary or during performance testing based on available capacity. In some examples, multiple canary tests can be run at the same time. As described herein, at regular intervals (e.g., daily or weekly), successful canary branches (e.g., the release branches corresponding to the stacks that pass the tests as a canary or during performance testing) are aggregated into a single mainline release.

For stacks released in parallel, a developer can initiate a scheduling request with the stack manager, specifying parameters for testing. For example, the parameters can include a percentage of traffic for the stack, a minimum period of time needed before promotion to full production is considered safe, allowed hours of operation, and/or the priority (e.g., indicating a level of priority for testing the stack). The stack manager then triggers the orchestrator to apply the BAU-PROD config template, setting the final config and scale to production values. As described herein, the test framework is triggered to perform sanity testing to ensure the stack continues to work as expected in the final configuration. According to some examples, sanity testing can include the fewest number of tests needed to ensure all core components are operating. If sanity testing fails, the release is aborted (e.g., stack is not added to queue). Otherwise, the stack can be added to a queue of environments for testing in the canary phase, where the stack will wait until a free timeslot is available. The stack manager can schedule stacks for testing based on stack-specific parameters and global parameters including allowed hours of operation, maximum combined percentage allowed of traffic for all canaries, maximum simultaneous canaries, and/or traffic routing change cooldown period (prevents over frequent changes from disrupting users).

As described herein, stacks in the queue can be tested in the canary stage as free slots become available from successfully completed stacks progressing from the canary stage (e.g., such that the stack stops receiving traffic and is marked eligible for mainline release), or from aborted anomalous stacks that fail to progress from the canary stage, e.g., which stop receiving traffic when anomalous behavior is detected by the application monitor. For example, responsive to the indication that the new programmatic environment successfully completed the suite of tests for progressing to the next stage, the system can record the new programmatic environment as a reference programmatic environment.

According to some embodiments, the module can facilitate the release of a mainline release. As referred to herein, a mainline release can refer to a primary, official version of a software product that is provided to the general public (e.g., via network traffic). The mainline release can be automatically created on a recurring interval, such as daily or weekly. On each interval, the stack manager can create a new mainline release branch and merge release branches for all successful stacks on the “canary” stage into the new mainline branch. In some examples, if there are merge conflicts that cannot be resolved automatically, the mainline release process aborts and a developer can be prompted (e.g., via a notification) to manually resolve the conflict.

A new stack is created from the new mainline release branch and the BAU-PROD configuration template can be applied. The programmatic environment maintenance module 354 can prompt the testing module 356 to perform E2E tests using test framework (e.g., connected to live systems). Upon receiving an indication from the testing module 356 that one or more of the E2E tests have failed, the module can alert developers via communication module 352, and corrections must be made before the progression can continue. For example, the communication module 352 can transmit a notification to a remote device, such as user device(s) 310 of a developer. Corrections can be made by updating and committing artifacts in the release branch.

According to some examples, a stack cannot be changed directly. A second release branch and second stack are created from mainline branch and the BAU-PROD config template can be applied. Sanity testing can be performed on the second new mainline stack and the release is aborted if the sanity testing fails. The network configuration module 358 (e.g., application gateway) can be given new traffic routing percentages. All traffic can be divided between the two new release stacks and the old full production stacks can no longer receive traffic. In some examples, the old stacks are retained for rollback or troubleshooting as described herein. In some examples, if a threshold number of stacks are queued for canary testing, the stack manager can apply a smaller configuration template (e.g., MIN-PROD or HIBERNATION) to save on infrastructure costs. In this case, BAU-PROD can be re-applied to the stacks and minimal sanity testing will need to be performed again before proceeding with the canary stage.

As described herein, certain old stacks are retained for rollback or troubleshooting. For example, old stacks can be kept as a version to revert to and direct traffic to when newer stacks malfunction. In some embodiments, the most recent old stacks are kept as-is for quickest possible rollback. These most recent old stacks can be referred to as N−1 (“N minus 1”) stacks where N refers to the current release version serving live traffic. Older (e.g., referred to as N−2) stacks are scaled down using the MIN-PROD configuration template to conserve resources, balancing cost with a speedy enough rollback. Oldest (e.g., referred to as N−3) stacks are scaled down using the HIBERNATION configuration template to the least cost infrastructure possible. Eventually the oldest (N−4) stacks age out and are automatically deleted. In some cases, if needed, any release branch (even if all stacks were deleted) can be restored to a new stack.

As described herein, the stacks can be monitored by the programmatic environment management module. The module (e.g., application monitor) can watch some or all stacks that are currently receiving live traffic in order to check telemetry for errors, such as when execution fails, and performance, such as when execution timed-out or took too long to complete. The module can also perform periodic sanity testing (e.g., submit a test order every 15 minutes for an ecommerce application), and/or transaction trend analysis (e.g., no obvious issues but order trend is lower than expected for an ecommerce application). Responsive to determining that at least one value of the one or more metrics does not exceed a predetermined threshold, the system can reconfigure the volume of network flow processed by the programmatic environment.

According to some examples, global and stack-specific performance envelopes can be defined, e.g., by developers. As referred to herein, a performance envelope can refer to a predefined boundary or limit within which the system is expected to operate efficiently and reliably. The boundaries can encompass various aspects such as response times, throughput, resource utilization and scalability. In some examples, stacks in the “canary” stage can typically have stricter performance envelopes than full production stacks (e.g., such as lower or higher thresholds with smaller tolerances). If a stack in the “canary” stage, for example, falls outside its envelope, traffic can be rerouted or prevented from being sent to the stack.

If multiple production stacks fall outside of the envelope, all traffic is rerouted to two or more older production stacks (e.g., N−1 production stacks as described herein). Alternatively, or additionally, if a single production stack falls outside of the envelope, the share of traffic for the stack can be routed to the other N stacks and the building of one or more new N stack is triggered. As new N stacks are ready, the share of live traffic is distributed evenly to them. In some cases, if a new stack becomes anomalous, traffic is rerouted to two or more N−1 (last known good) production stacks.

According to some examples, certain changes can be made to stacks while online (i.e., while the stack is taking live traffic) without requiring a new release. For example, potentially safe online changes can include configuration changes if the changes are compatible with existing provisioned infra and running code and if the changes take effect dynamically (e.g., change is auto-detected and loaded by running code or the change triggers a “rolling restart” of redundant components). Similarly, changes to infrastructure for scaling the infrastructure up or down can be considered if the affected infra supports online scaling (e.g., Kubernetes container pods, AWS RDS databases). These types of changes can be implemented as configuration templates and applied by initiating an “apply online config template” operation with the stack manager. Online configuration templates can be manually tested by developers in nonproduction before being used in production to insure (1) changes can successfully complete under load from user requests and (2) the stack can continue to operate within performance margins while changes are in progress. Once the changes are tested manually by developers, the changes can be implemented as described. To protect overall application stability and performance, the stack manager can only execute online changes on a single live stack at a time. If a stack becomes anomalous while an online change template is being applied, the application monitor can report the failure, and the stack manager can follow the abort/failover/rollback process described herein.

### Testing Module

The testing module 356 can perform tests when prompted, e.g., by a developer, automatically after the expiry of an interval of time (e.g., for regular monitoring of the stacks), and/or when a stack attempts to progress to a new stage. As referred to herein, a test can refer to computer program code enabled to make deterministic calls to run executable code and configuration that defines specific pass/fail criteria for the results. In some examples, the test information can be accessible and modifiable via the release branch specific to a stack. Testing frameworks can be used to execute tests against a stack to determine if the functional behavior of the stack is correct including through usage of mock tests, end-to-end (E2E) tests, and/or sanity tests.

As described herein, the programmatic environment management module 354 (e.g., stack manager) can trigger the test framework to run tests as needed, e.g., via testing module 356. For example, the system can periodically trigger automated minimal sanity testing for all live stacks, and upon execution of the tests, the testing module 356 can transmit or pass the results of the tests to the programmatic environment management module 354 for further action.

Further, tests can be run to determine whether or not to progress a stack to a new stage. Depending on the current state, e.g., stage, of the stack, the type of tests executed by the testing module 356 can vary. For example, mock tests that do not use live data can be run on stacks in the development stage, end-to-end tests can be run on stacks in the functional testing stage, and/or sanity tests can be run on stacks in the performance testing stage, e.g., using live data. Once stacks are developed enough to be in the full production stage, the stacks can be continually monitored through periodic testing to ensure correct functionality.

### Network Configuration Module

The amount of traffic routed to each of the stacks can be decided by programmatic environment management module 354. Responsive to an indication from the programmatic environment management module 354, the network configuration module 358 can be configured to modify the percentage and/or share of traffic for each stack. According to some examples, the network configuration module 358 can include an application gateway. As referred to herein, an application gateway can include a load balancer/proxy that receives all application traffic and then routes a percentage to various available stacks, e.g., based on the percentage values passed by programmatic environment management module 354.

As described herein, during generation of new stacks, the programmatic environment management module 354 can provision new infrastructure for each stack, which includes generating and using stack-unique configuration values. One of the key stack-unique values that is generated includes the single point of entry, e.g., endpoint, which is to be used by the application gateway for routing live traffic to the stack. In some examples, the single point of entry can be desirable to have few or no alternative ways to access the application and infra.

### Flow Diagram

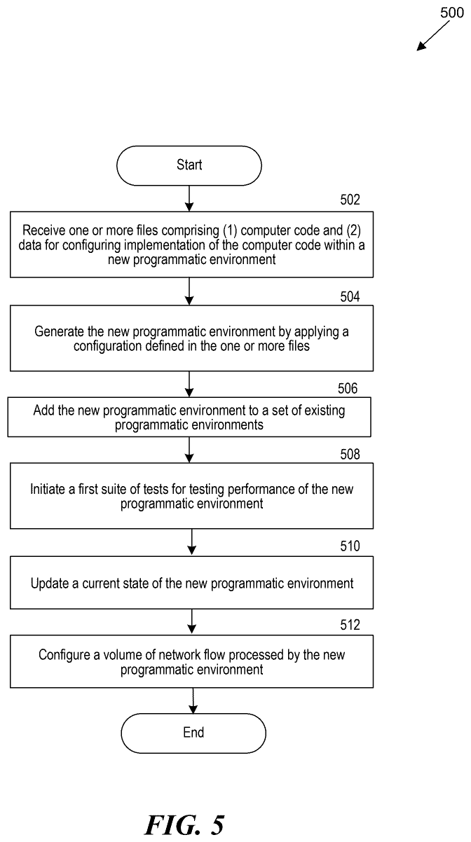

FIG. 5 is a flow diagram illustrating a process for continuous deployment and integration of computer programs within a coding infrastructure. Process 500 begins at block 502 where a system (e.g., such as continuous deployment/integration system 350) receives one or more files comprising (1) computer code and (2) data for configuring implementation of the computer code within a new programmatic environment (as discussed above in reference to the communication module 352).

At block 504, process 500 includes generating the new programmatic environment by applying a configuration defined in the one or more files (as discussed above in reference to the programmatic environment management module 354). Process 500 then proceeds to block 506 where a system adds the new programmatic environment to a set of existing programmatic environments. At block 508, process 500 initiates a first suite of tests for testing performance of the new programmatic environment or for functional testing of the new programmatic environment. The process proceeds to block 510, where a current state of the new programmatic environment is updated, e.g., responsive to successful completion of the tests. At block 512, the system can configure a volume of network flow processed by the new programmatic environment.

As described herein, the continuous deployment process may include one or more different stages. According to some examples, each stage may include one or more assessments (e.g., tests including performance testing and/or functional testing) as well as other processing steps. In the example of FIG. 5, a first stage may include block 506, 508, 510, and/or 512 and the process can continue on by looping back to the steps at block 506, 508, block 510, and/or block 512. In one example, a stage can be a functional testing stage where a first configuration is applied, e.g., to determine what needs to be executed at a given stage and how to prepare the environment for that given stage. This may occur, for example, as part of block 506. Then, a first set of rules or tests can be initiated (e.g., block 508), and the process may continue on. The process may then loop back once a second stage such as performance testing begins, by initiating the tests associated with the new stage.

### Computer System

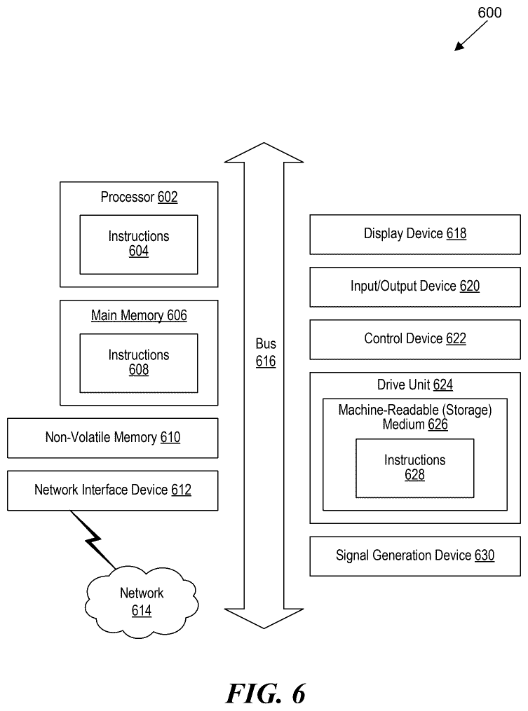

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 shares a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC) or a distributed system such as a mesh of computer systems, or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A computer-implemented method for continuous deployment and integration of computer programs within a coding infrastructure, the method comprising:
receiving one or more files comprising (1) computer code and (2) data for configuring implementation of the computer code within a new programmatic environment,
wherein the new programmatic environment comprises a runnable collection of provisioned infrastructure containing compiled executable code corresponding to the computer code and configuration data for the computer code;
generating the new programmatic environment by applying a configuration defined in the one or more files;
adding the new programmatic environment to a set of existing programmatic environments, wherein each programmatic environment of the set is classified by a current state of a plurality of states each indicating a stage of development of a programmatic environment, and wherein each state includes a suite of tests for evaluating functionality of each programmatic environment;
initiating execution of a first suite of tests for testing performance of the new programmatic environment;
responsive to an indication that the new programmatic environment successfully completed the first suite of tests, updating the current state of the new programmatic environment; and
configuring a volume of network flow processed by the new programmatic environment.

2. The method of claim 1, further comprising: responsive to receiving an updated version of the one or more files, generating a second programmatic environment based on the updated version.

3. The method of claim 1, further comprising:
monitoring performance of the new programmatic environment based on values of one or more metrics; and
responsive to determining that at least one value of the one or more metrics does not exceed a predetermined threshold, reconfiguring the volume of network flow processed by the programmatic environment.

4. The method of claim 1, further comprising: responsive to an indication that the programmatic environment failed the first suite of tests, preventing network flow volume from being processed by the programmatic environment.

5. The method of claim 1, further comprising: responsive to an indication that the programmatic environment failed the first suite of tests, transmitting, to a remote device, a notification of failure of the first suite of tests.

6. The method of claim 1, wherein the new programmatic environment is executed independently of each of the existing programmatic environments of the set and wherein a new programmatic environment services user requests at a same time as the set of existing programmatic environments without transaction inconsistencies.

7. The method of claim 1, further comprising: responsive to the indication that the new programmatic environment successfully completed the first suite of tests, recording the new programmatic environment as a reference programmatic environment.

8. One or more non-transitory, computer-readable media containing instructions that, when executed by a processor, perform a method for continuous deployment and integration of computer programs within a coding infrastructure, the method comprising:
receiving one or more files comprising (1) computer code and (2) data for configuring implementation of the computer code within a new programmatic environment;
generating the new programmatic environment by applying a configuration defined in the one or more files;
adding the new programmatic environment to a set of existing programmatic environments, wherein each programmatic environment of the set is classified by a current state of a plurality of states each indicating a stage of development of a programmatic environment, and wherein each state includes a suite of tests for evaluating functionality of each programmatic environment;
initiating execution of a first suite of tests for testing performance of the new programmatic environment;
responsive to an indication that the new programmatic environment successfully completed the first suite of tests, updating the current state of the new programmatic environment; and
configuring a volume of network flow processed by the new programmatic environment.

9. The one or more non-transitory, computer-readable media of claim 8, wherein the method further comprises: responsive to receiving an updated version of the one or more files, generating a second programmatic environment based on the updated version.

10. The one or more non-transitory, computer-readable media of claim 8, wherein the method further comprises:
monitoring performance of the new programmatic environment based on values of one or more metrics; and
responsive to determining that at least one value of the one or more metrics does not exceed a predetermined threshold, reconfiguring the volume of network flow processed by the programmatic environment.

11. The one or more non-transitory, computer-readable media of claim 8, wherein the method further comprises: responsive to an indication that the programmatic environment failed the first suite of tests, preventing network flow volume from being processed by the programmatic environment.

12. The one or more non-transitory, computer-readable media of claim 8, wherein the method further comprises: responsive to an indication that the programmatic environment failed the first suite of tests, transmitting, to a remote device, a notification of failure of the first suite of tests.

13. The one or more non-transitory, computer-readable media of claim 8, wherein the new programmatic environment is executed independently of each of the existing programmatic environments of the set and wherein the new programmatic environment services user requests at a same time as the set of existing programmatic environments without transaction inconsistencies.

14. The one or more non-transitory, computer-readable media of claim 8, wherein the method further comprises: responsive to the indication that the new programmatic environment successfully completed the first suite of tests, recording the new programmatic environment as a reference programmatic environment.

15. A system for continuous deployment and integration of computer programs within a coding infrastructure, the system comprising:
one or more processors; and
one or more non-transitory, computer-readable media storing instructions that, when executed by the one or more processors, cause operations comprising:
receiving one or more files comprising (1) computer code and (2) data for configuring implementation of the computer code within a new programmatic environment;
generating the new programmatic environment by applying a configuration defined in the one or more files;
adding the new programmatic environment to a set of existing programmatic environments, wherein each programmatic environment of the set is classified by a current state of a plurality of states each indicating a stage of development of a programmatic environment, and wherein each state includes a suite of tests for evaluating functionality of each programmatic environment;
initiating execution of a first suite of tests for testing performance of the new programmatic environment;
responsive to an indication that the new programmatic environment successfully completed the first suite of tests, updating the current state of the new programmatic environment; and
configuring a volume of network flow processed by the new programmatic environment.

16. The system of claim 15, wherein the one or more non-transitory, computer-readable media further cause operations comprising: responsive to receiving an updated version of the one or more files, generating a second programmatic environment based on the updated version.

17. The system of claim 15, wherein the one or more non-transitory, computer-readable media further cause operations comprising:
monitoring performance of the new programmatic environment based on values of one or more metrics; and
responsive to determining that at least one value of the one or more metrics does not exceed a predetermined threshold, reconfiguring the volume of network flow processed by the programmatic environment.

18. The system of claim 15, wherein the one or more non-transitory, computer-readable media further cause operations comprising: responsive to an indication that the programmatic environment failed the first suite of tests, transmitting, to a remote device, a notification of failure of the first suite of tests.

19. The system of claim 15, wherein the new programmatic environment is executed independently of each of the existing programmatic environments of the set and wherein the new programmatic environment services user requests at a same time as the set of existing programmatic environments without transaction inconsistencies.

20. The system of claim 15, wherein the one or more non-transitory, computer-readable media further cause operations comprising: responsive to the indication that the new programmatic environment successfully completed the first suite of tests, recording the new programmatic environment as a reference programmatic environment.
